(19) United States
(12) Patent Application Publication
(10) Pub. No.: US 2023/0210066 A1
(43) Pub. Date: Jul. 6, 2023

(54) MODULAR IRRIGATION TOWER

(71) Applicant: Lindsay Corporation, Omaha, NE (US)

(72) Inventors: Michael Charles South, Council Bluffs, IA (US); Matthew J. Dudik, Elkhorn, NE (US)

(73) Assignee: Lindsay Corporation, Omaha, NE (US)

(21) Appl. No.: 17/568,762

(22) Filed: Jan. 5, 2022

(51) Int. Cl. A01G 25/09

(52) U.S. Cl. CPC A01G 25/092

(57) ABSTRACT

A mobile tower for use with an irrigation system having horizontally-extending spans, the mobile tower comprising a frame and a number of wheels. The frame includes a crossbeam, first and second diagonal legs, first and second lower gussets, and an upper bracket. The crossbeam, first diagonal leg, and second diagonal leg include tubular members having gusset connectors. The tubular members are interchangeable and adaptable with other tubular members.

Mobile irrigation systems, and their mobile irrigation towers in particular, are often tailored to the fields and agricultural plans for which they will be used, but fields, agricultural plans, and technology often change after the mobile irrigation systems are installed. For example, some field areas may become unusable from flooding while other areas may be cleared for expansion or taken out of service. Similarly, agricultural plans may be modified due to previous yields and changing market conditions. Improved motors, wheels, and other advancements are also introduced into the market that may alter irrigation system performance. Unfortunately, these changes often render existing mobile irrigation towers inefficient and even obsolete, thus requiring them to be replaced at great expense.

### SUMMARY OF THE INVENTION

Embodiments of the present invention solve the above-mentioned problems and other problems and provide a distinct advancement in the art of mobile irrigation towers. More particularly, the invention provides a mobile irrigation tower that includes modular components that are interchangeable and adaptable with other modular components, thus allowing the mobile irrigation tower and the mobile irrigation system in which it is used to be modified, retrofitted, and upgraded.

An embodiment of the invention is a mobile irrigation tower broadly comprising a frame, a number of wheels, and a drive motor. The mobile irrigation tower may be one of several similar mobile irrigation towers of a mobile irrigation system.

The frame includes a crossbeam, a first diagonal leg, a second diagonal leg, a first lower gusset, a second lower gusset, and an upper bracket. The frame supports a span of the mobile irrigation system and elevates the span above a ground surface.

The crossbeam extends horizontally between the wheels and includes a first tubular member, a second tubular member, and a motor mounting gusset. The crossbeam connects to the first lower gusset and the second lower gusset.

The first tubular member includes opposing first and second gusset connectors near its ends and is connected to the first lower gusset and to the motor mounting gusset. The first and second gusset connectors are positioned and welded in sidewall end slots at the ends of the first tubular member.

The second tubular member includes opposing first and second gusset connectors near its ends and is connected to the second lower gusset and to the motor mounting gusset. The first and second gusset connectors of the second tubular member are positioned and welded in sidewall end slots at the ends of the second tubular member.

The motor mounting gusset connects the first tubular member and the second tubular member of the crossbeam and supports the drive motor. The motor mounting gusset includes mounting holes or structure for attaching or fastening the first tubular member, the second tubular member, and the drive motor thereto.

The first diagonal leg extends vertically between and connects to the first lower gusset and the upper bracket. The first diagonal leg includes a tubular member having opposing first and second gusset connectors and a brace connector.

The first and second gusset connectors of the first diagonal leg are positioned and welded in sidewall end slots at the ends of the first diagonal leg. In one embodiment, the first gusset connector of the first diagonal leg extends in a vertical plane parallel to an axis of the tubular member of the first diagonal leg, and the second gusset connector extends in a different plane parallel to the axis of the tubular member of the first diagonal leg. In other words, the first and second gusset connectors of the first diagonal leg are not co-planar.

The brace connector is positioned and welded in sidewall slots between the ends of the first diagonal leg. The brace connector connects a brace of an adjacent span to the frame.

The second diagonal leg extends vertically between and connects to the second lower gusset and the upper bracket. The second diagonal leg includes a tubular member having opposing first and second gusset connectors and a brace connector.

The first and second gusset connectors of the second diagonal leg are positioned and welded in sidewall end slots at the ends of the second diagonal leg. In one embodiment, the first gusset connector of the second diagonal leg extend in a vertical plane parallel to an axis of the tubular member of the second diagonal leg, and the second gusset connector of the second diagonal leg extends in a different plane parallel to the axis of the tubular member of the second diagonal leg. In other words, the first and second gusset connectors of the second diagonal leg are not co-planar.

The brace connector of the second diagonal leg is positioned and welded in sidewall slots between the ends of the second diagonal leg. The brace connector connects a brace of the adjacent span to the frame.

The first lower gusset connects the crossbeam and the first diagonal leg. The first lower gusset is also a mounting point for the first wheel.

The second lower gusset connects the crossbeam and the second diagonal leg. The second lower gusset is also a mounting point for the second wheel.

The upper bracket extends between the first diagonal leg and the second diagonal leg and supports a conduit of the mobile irrigation system near a top of the frame. The upper bracket includes a U-shaped section and a cap section.

The U-shaped section cradles the conduit from underneath and is connected to the second gusset connector of the first diagonal leg and the second gusset connector of the second diagonal leg. The cap section extends over the conduit and is connected to the second gusset connector of the first diagonal leg and the second gusset connector of the second diagonal leg.

The wheels are rotatably mounted to the first and second lower gussets and may include treaded tires, airless flexible tires, a track belt assembly, or the like. Each wheel may be a drive wheel, and hence may be drivably connected to the drive motor via the drive train.

The drive motor may be an alternating current (AC) motor or a direct current (DC) motor. The drive motor is drivably connected to one or both of the wheels via a drive train, which may include a drive shaft, a chain, a belt, a gearbox, or the like. Alternatively, separate drive motors may be used to drive each wheel.

The above-described mobile irrigation tower provides several advantages. For example, the tubular members of the crossbeam, first diagonal leg, and second diagonal leg may be interchangeable and adaptable with other tubular members and mountable components. For example, additional tubular members can be used to lengthen the crossbeam, first diagonal leg, and second diagonal leg, thereby scaling up the frame without introducing new stress or force components (the currently existing forces will only increase). Similarly, the tubular members can be replaced with shorter tubular members to shorten the crossbeam, first diagonal leg, and second diagonal leg, thereby scaling down the frame. These changes can be performed in the field without dismantling the mobile irrigation system.

The tubular members can also be replaced or used with other tubular members and mountable components to accommodate different truss structures, wheel and drive configurations, and other variations within the mobile irrigation system. For example, if the mobile irrigation system is expanded to include a fifth span, the tubular members of the first and second diagonal legs may be replaced with tubular members that include brace connectors on both sides thereof, instead of on just one side. As another example, the mobile irrigation tower may be retrofitted with an improved motor that may require the first and second tubular members of the crossbeam to be replaced with tubular members of different lengths.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective view of a mobile irrigation system including a mobile irrigation tower constructed in accordance with an embodiment of the invention;

FIG. 2 is a perspective view of the mobile irrigation tower of FIG. 1;

FIG. 3 is a rear perspective view of the mobile irrigation tower of FIG. 1;

FIG. 4 is an enlarged partial cutaway view of a portion of the mobile irrigation tower of FIG. 1;

FIG. 5 is an enlarged partial cutaway view of another portion of the mobile irrigation tower of FIG. 1; and

FIG. 6 is an exploded view of certain components of the mobile irrigation tower of FIG. 1.

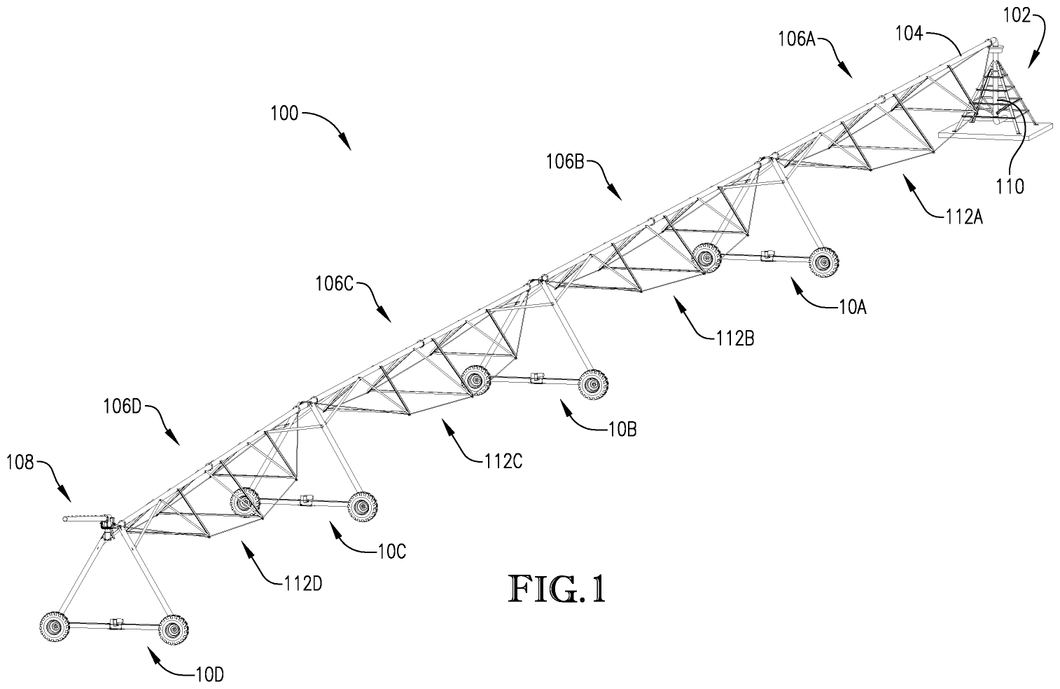

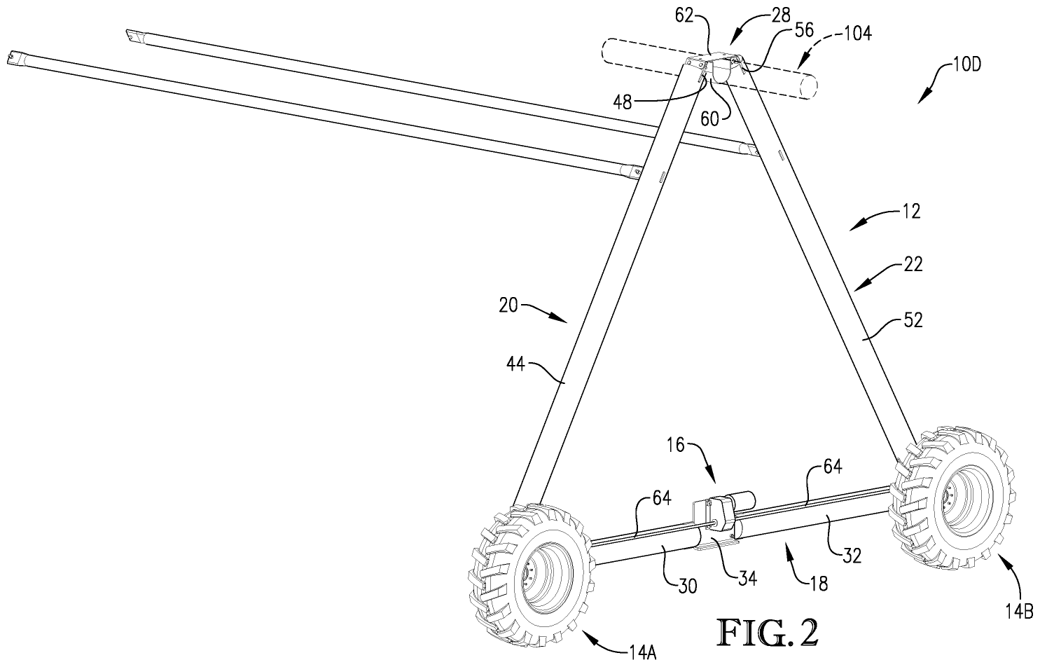

The drawing figures do not limit the current invention to the specific embodiments disclosed and described herein. The drawings are not necessarily to scale, emphasis instead being placed upon clearly illustrating the principles of the invention.

### Detailed Description of the Embodiments

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Turning to the drawing figures, a plurality of mobile irrigation towers 10A-D constructed in accordance with embodiments of the invention are illustrated. The mobile irrigation towers 10A-D are configured to be used as components of an irrigation system 100.

An exemplary embodiment of the irrigation system 100 broadly comprises a central pivot 102, a conduit 104, a plurality of interconnected radially outward extending spans 106A-D pivotally connected to the central pivot 102 and including mobile irrigation towers 10A-D, and an end gun 108. The irrigation system 100 may also comprise an extension arm (also commonly referred to as a “swing arm” or “corner arm”) pivotally connected to a free end of the outermost span 106D. The irrigation system 100 may further comprise a main controller that controls the overall operation of the system along with communication elements that provide wireless or wired communication with external electronic devices or systems. The irrigation system 100 may also be embodied by a lateral, or linear, move apparatus without departing from the scope of the current invention.

The central pivot 102 may include a support structure 110 or a mobile tower about which the spans 106A-D may pivot. The central pivot 102 has access to a fluid source, such as a well, water tank, or other source of water, and may also be coupled with a tank or other source of agricultural products to inject fertilizers, pesticides and/or other chemicals into the fluid for application during irrigation.

The conduit 104 includes a plurality of fluid-carrying tubes coupled to one another to form a continuous fluid-carrying pipe that extends the length of the spans 106A-D. The conduit 104 is supported by the central pivot 102 and receives fluid from the fluid source.

Each span 106A-D includes a corresponding truss structure 112A-D supported on a mobile tower discussed in more detail below. Each span 106A-D may also include a plurality of fluid distribution elements. The fluid distribution elements include sprayers, spreaders, sprinklers, diffusers, or the like, each optionally attached to a drop hose. The fluid distribution elements are fluidly coupled to the conduit 104 in order to access and distribute the fluid.

Each truss structure 112A-D includes a plurality of beam members coupled to one another to form a load-bearing truss. The truss structures 112A-D support the conduit 104 and the fluid distribution elements. In addition, the truss structures 112A-D also connect adjacent mobile towers and the central pivot 102.

Each span 106A-D may further include one or more valves coupled to the conduit 104 which control the flow of fluid through the conduit 104. The opening and closing of the valves may be automatically controlled with an electronic signal or digital data from a control system locally integrated with the irrigation system 100 or externally located to provide remote control.

The mobile irrigation towers 10A-D are substantially similar so only mobile irrigation tower 10D will be discussed in detail. The mobile irrigation tower 10D broadly comprises a frame 12, a plurality of wheels 14A, B, and a drive motor 16.

The frame 12 includes a crossbeam 18, a first diagonal leg 20, a second diagonal leg 22, a first lower gusset 24, a second lower gusset 26, and an upper bracket 28. The frame 12 supports the span 106D and elevates the span 106D above the ground surface.

The crossbeam 18 extends horizontally between the wheels 14A,B and includes a first tubular member 30, a second tubular member 32, and a motor mounting gusset 34. The crossbeam 18 connects to the first lower gusset 24 and the second lower gusset 26.

The first tubular member 30 includes opposing first and second gusset connectors 36, 38 near its ends and may be connected to the first lower gusset 24 and to the motor mounting gusset 34. The first and second gusset connectors 36, 38 may be flanges, plates, or any other suitable connecting interface. The first and second gusset connectors 36, 38 may be positioned and welded in sidewall end slots at the ends of the first tubular member 30. In one embodiment, the first and second gusset connectors 36, 38 extend in a vertical plane parallel to an axis of the first tubular member 30. The first tubular member 30 may account for approximately half the length of the crossbeam 18.

The second tubular member 32 includes opposing first and second gusset connectors 40, 42 near its ends and may be connected to the second lower gusset 26 and to the motor mounting gusset 34. The first and second gusset connectors 40, 42 may be flanges, plates, or any other suitable connecting interface. The first and second gusset connectors 40, 42 may be positioned and welded in sidewall end slots at the ends of the second tubular member 32. In one embodiment, the first and second gusset connectors 40, 42 extend in a vertical plane parallel to an axis of the second tubular member 32. The second tubular member 32 may account for approximately half the length of the crossbeam 18.

The motor mounting gusset 34 connects the first tubular member 30 and the second tubular member 32 of the crossbeam 18 and supports the drive motor 16. The motor mounting gusset 34 may be a flange, plate, bracket or any other suitable connecting interface. The motor mounting gusset 34 includes mounting holes or structure for attaching or fastening the first tubular member 30 (via the second gusset connector 38), the second tubular member 32 (via the first gusset connector 40), and the motor drive motor 16 thereto. In one embodiment, the motor mounting gusset 34 extends in a vertical plane.

The crossbeam 18 provides horizontal rigidity to the frame 12 and a mounting location for the drive motor 16 as discussed above. Furthermore, the first and second tubular members 30, 32 are interchangeable and adaptable with other tubular members, which allows for shortening or lengthening the crossbeam 18 and adapting to different wheel and drive configurations and other variations within the mobile irrigation system 100 as described in more detail below.

The first diagonal leg 20 extends vertically between and connects to the first lower gusset 24 and the upper bracket 28. The first diagonal leg 20 includes a tubular member 44 having opposing first and second gusset connectors 46, 48 and a brace connector 50.

The first and second gusset connectors 46, 48 may be flanges, plates, or any other suitable connecting interface. The first and second gusset connectors 46, 48 may be positioned and welded in sidewall end slots at the ends of the first diagonal leg 20. In one embodiment, the first gusset connector 46 extends in a vertical plane parallel to an axis of the tubular member 44, and the second gusset connector 48 extends in a different plane parallel to the axis of the tubular member 44. In other words, the first and second gusset connectors 46, 48 may not be co-planar.

The brace connector 50 may be positioned and welded in sidewall slots between the ends of the first diagonal leg 20. The brace connector 50 connects the brace 114A to the frame 12. The brace connector 50 may be a flange, plate, or any other suitable connecting interface.

The first diagonal leg 20 provides vertical rigidity and horizontal stability to the frame 12. Furthermore, the tubular member 44 is interchangeable and adaptable with other tubular members, which allows for shortening or lengthening the first diagonal leg 20 and adapting to different truss structures and variations within the mobile irrigation system 100 as described in more detail below.

The second diagonal leg 22 extends vertically between and connects to the second lower gusset 26 and the upper bracket 28. The second diagonal leg 22 includes a tubular member 52 having opposing first and second gusset connectors 54, 56 and a brace connector 58.

The first and second gusset connectors 54, 56 may be flanges, plates, or any other suitable connecting interface. The first and second gusset connectors 54, 56 may be positioned and welded in sidewall end slots at the ends of the second diagonal leg 22. In one embodiment, the first gusset connector 54 extends in a vertical plane parallel to an axis of the tubular member 52, and the second gusset connector 56 extends in a different plane parallel to the axis of the tubular member 52. In other words, the first and second gusset connectors 54, 56 may not be co-planar.

The brace connector 58 may be positioned and welded in sidewall slots between the ends of the second diagonal leg 22. The brace connector 58 connects the brace 114B to the frame 12. The brace connector 58 may be a flange, plate, or any other suitable connecting interface.

The second diagonal leg 22 provides vertical rigidity and horizontal stability to the frame 12. Furthermore, the tubular member 52 is interchangeable and adaptable with other tubular members, which allows for shortening or lengthening the second diagonal leg 22 and adapting to different truss structures and variations within the mobile irrigation system 100 as described in more detail below.

The first lower gusset 24 connects the crossbeam 18 and the first diagonal leg 20. The first lower gusset 24 is also a mounting point for the first wheel 14A. The first lower gusset 24 may be a flange, plate, bracket or any other suitable connecting interface. The first lower gusset 24 includes mounting holes or structure for attaching or fastening the crossbeam 18 (via the first gusset connector 36), the first diagonal leg 20 (via the first gusset connector 46), and the first wheel 14A thereto. In one embodiment, the first lower gusset 24 extends in a vertical plane.

The second lower gusset 26 connects the crossbeam 18 and the second diagonal leg 22. The second lower gusset 26 is also a mounting point for the second wheel 14B. The second lower gusset 26 may be a flange, plate, bracket or any other suitable connecting interface. The second lower gusset 26 includes mounting holes or structure for attaching or fastening the crossbeam 18 (via the second gusset connector 42), the second diagonal leg 22 (via the first gusset connector 54), and the second wheel 14B thereto. In one embodiment, the second lower gusset 26 extends in a vertical plane.

The upper bracket 28 extends between the first diagonal leg 20 and the second diagonal leg 22 and supports the conduit 104 (and hence the span 106D) near a top of the frame 12. The upper bracket 28 includes a U-shaped section 60 and a cap section 62.

The U-shaped section 60 cradles the conduit 104 from underneath and is connected to the second gusset connector 48 of the first diagonal leg 20 and the second gusset connector 56 of the second diagonal leg 22. The upper bracket 28 may form a double shear connection with the second gusset connector 48 of the first diagonal leg and the cap section 62. The upper bracket 28 may form another double shear connection with the second gusset connector 56 of the second diagonal leg and the cap section 62.

The cap section 62 extends over the conduit 104 and is connected to the second gusset connector 48 of the first diagonal leg 20 and the second gusset connector 56 of the second diagonal leg 22. The cap section 62 may form double shear connections as discussed above.

The plurality of wheels 14A,B are substantially similar so only wheel 14A will be described in detail. Wheel 14A may include single or multiple wheel and treaded tire combinations, an airless flexible tire, a track belt assembly, or the like. Wheel 14A may be a drive wheel, and hence may be drivably connected to the drive motor 16 via the drive train 64.

The drive motor 16 may be an alternating current (AC) motor or a direct current (DC) motor. The drive motor 16 may be drivably connected to at least one of the first wheel 14A and the second wheel 14B via a drive train 64, which may include a drive shaft, a chain, a belt, a gearbox, or the like. Alternatively, separate drive motors may be used to drive each wheel. In yet another embodiment, the drive motor 16 may be a hub motor mounted in one of the first and second wheels 14A,B. The drive motor 16 may be controlled by a variable frequency drive (VFD) motor controller or the like.

The above-described mobile irrigation tower 10D provides several advantages. For example, the tubular members 30, 32, 44, 52 of the crossbeam 18, first diagonal leg 20, and second diagonal leg 22 may be interchangeable and adaptable with other tubular members and mountable components. For example, additional tubular members can be used to lengthen the crossbeam 18, first diagonal leg 20, and second diagonal leg 22, thereby scaling up the frame 12 without introducing new stress or force components (the currently existing forces will only increase). Similarly, the tubular members 30, 32, 44, 52 can be replaced with shorter tubular members to shorten the crossbeam 18, first diagonal leg 20, and second diagonal leg 22, thereby scaling down the frame 12. These changes can be performed in the field without dismantling the mobile irrigation system 100.

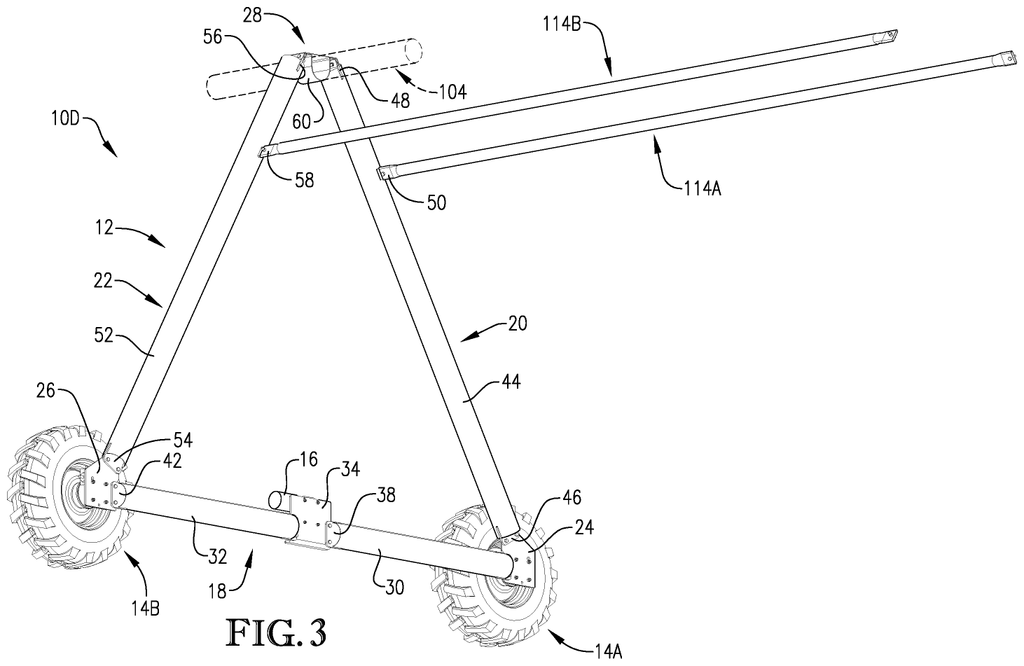

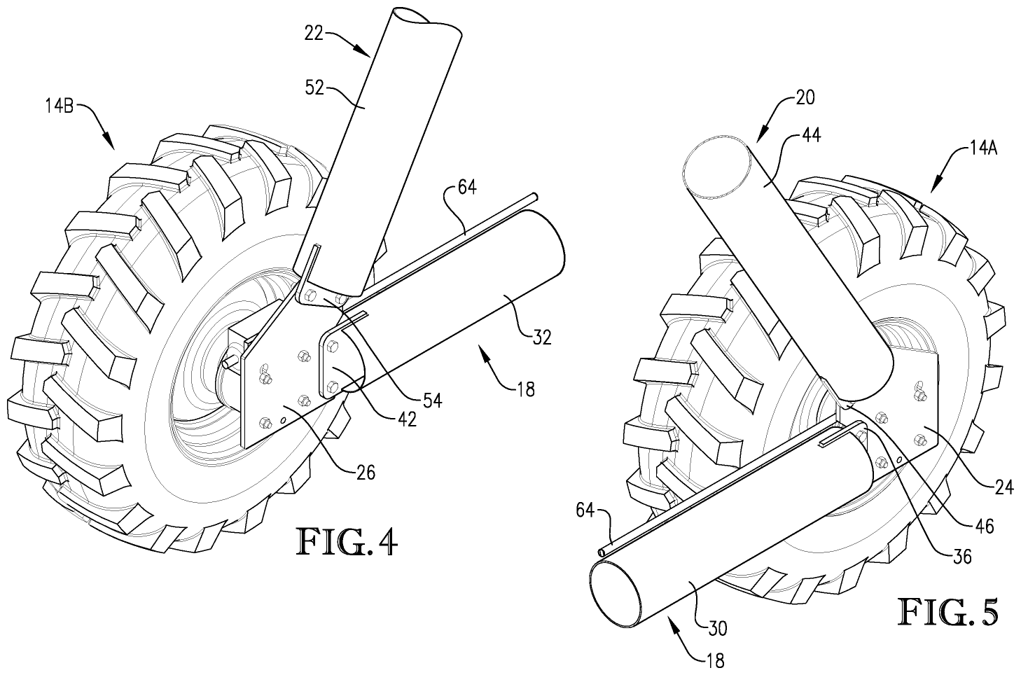

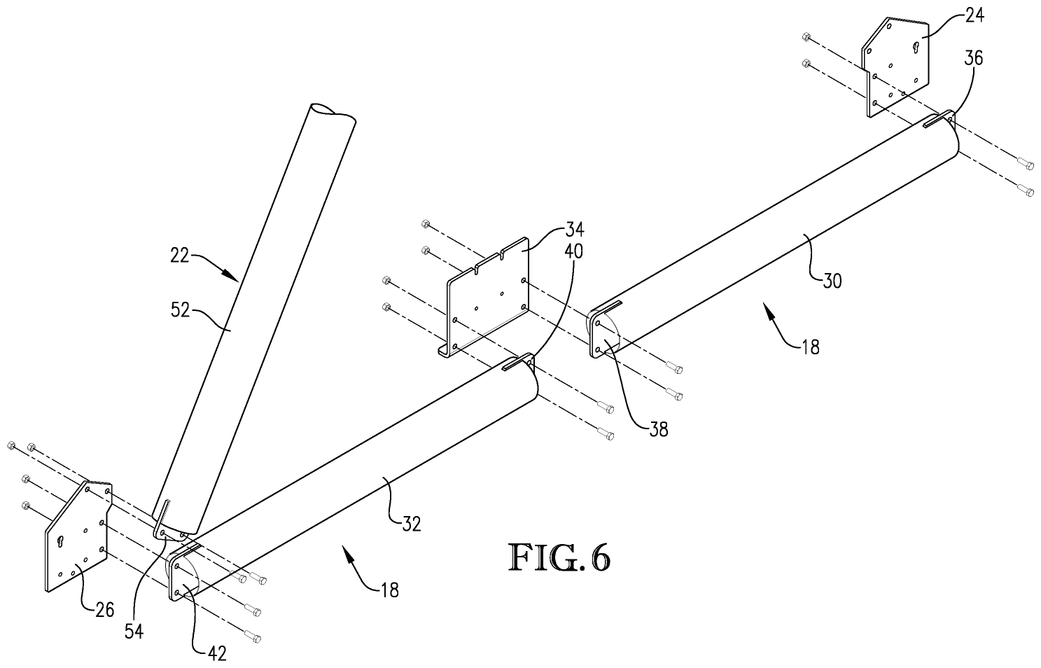

The tubular members 30, 32, 44, 52 can also be replaced or used with other tubular members and mountable components to accommodate different truss structures, wheel and drive configurations, and other variations within the mobile irrigation system 100. For example, if the mobile irrigation system 100 is expanded to include a fifth span, the tubular members 44, 52 of the first and second diagonal legs 20, 22 may be replaced with tubular members that include brace connectors on both sides thereof, instead of on just one side as seen in FIG. 3. Similarly, the mobile irrigation tower 10D may be retrofitted with an improved motor that may require the first and second tubular members 30, 32 of the crossbeam 18 to be replaced with tubular members of different lengths.

The first and second diagonal legs 20, 22 are singular legs extending in a vertical plane. The tubular members 44, 52 thereof are strong enough that diverging “double legs” are not needed. This allows for the frame 12 to be scaled up and down without having to change or redesign mounting structure at the top of the frame 12.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A mobile tower for use with an irrigation system having horizontally-extending spans, the mobile tower comprising:
a frame configured to support one of the horizontally-extending spans, the frame including:
a crossbeam including a tubular member having gusset connectors;
a first diagonal leg including a tubular member having gusset connectors;
a second diagonal leg including a tubular member having gusset connectors;
a first lower gusset connecting the first diagonal leg and the crossbeam via one of the gusset connectors of the first diagonal leg and one of the gusset connectors of the crossbeam;
a second lower gusset connecting the second diagonal leg and the crossbeam via one of the gusset connectors of the second diagonal leg and one of the gusset connectors of the crossbeam; and
an upper bracket connecting the first diagonal leg and the second diagonal leg via one of the gusset connectors of the first diagonal leg and one of the gusset connectors of the second diagonal leg,
the tubular members of the crossbeam, first diagonal leg, and second diagonal leg being interchangeable and adaptable with other tubular members; and
a plurality of wheels rotatably mounted on the frame for traversing a ground surface.

2. The mobile tower of claim 1, the tubular member of the first crossbeam being a first tubular member, the crossbeam further including a second tubular member having gusset connectors, the frame further including a third lower gusset connecting the first tubular member and the second tubular member, the mobile tower further comprising a drive motor mounted on the third lower gusset and a drive train drivably connecting the drive motor to at least one of the plurality of wheels.

3. The mobile tower of claim 3, the horizontally-extending spans including braces, the first diagonal leg and the second diagonal leg each including a brace connector for connecting to one of the braces.

4. The mobile tower of claim 1, the brace connectors being welded to the first diagonal leg and second diagonal leg.

5. The mobile tower of claim 1, the gusset connectors being welded to the tubular members.

6. The mobile tower of claim 5, the tubular members including sidewall end slots, the gusset connectors being positioned in the sidewall end slots.

7. The mobile tower of claim 1, the horizontally-extending spans including a conduit, the upper bracket including a U-shaped section for supporting the conduit.

8. The mobile tower of claim 7, the upper bracket further including a cap section configured to extend over the conduit, the U-shaped section and the cap section forming double shear connections with the gusset connectors of the first diagonal leg and the second diagonal leg.

9. The mobile tower of claim 1, the first diagonal leg and the second diagonal leg extending in a vertical plane.

10. The mobile tower of claim 1, the gusset connectors of the first diagonal leg extending parallel to an axis of the tubular member of the first diagonal leg and being oriented in different planes than each other, the gusset connectors of the second diagonal leg extending parallel to an axis of the tubular member of the second diagonal leg and being oriented in different planes than each other.

11. A mobile irrigation system comprising:
a central pivot including a support structure;
a fluid-carrying conduit supported by the central pivot and coupled to a fluid source;
a plurality of interconnected spans extending radially outward from the central pivot, each span including:
a plurality of fluid distribution members coupled to the conduit and configured to distribute fluid; and
a truss structure supporting the conduit and the plurality of fluid distribution members; and
a plurality of mobile towers each comprising:
a frame configured to support one of the horizontally-extending spans, the frame including:
a crossbeam including a tubular member having gusset connectors;
a first diagonal leg including a tubular member having gusset connectors;
a second diagonal leg including a tubular member having gusset connectors;
a first lower gusset connecting the first diagonal leg and the crossbeam via one of the gusset connectors of the first diagonal leg and one of the gusset connectors of the crossbeam;
a second lower gusset connecting the second diagonal leg and the crossbeam via one of the gusset connectors of the second diagonal leg and one of the gusset connectors of the crossbeam; and
an upper bracket connecting the first diagonal leg and the second diagonal leg via one of the gusset connectors of the first diagonal leg and one of the gusset connectors of the second diagonal leg,
the tubular members of the crossbeam, first diagonal leg, and second diagonal leg being interchangeable and adaptable with other tubular members; and
a plurality of wheels rotatably mounted on the frame for traversing a ground surface.

12. The mobile tower of claim 11, the tubular member of the first crossbeam being a first tubular member, the crossbeam further including a second tubular member having gusset connectors, the frame further including a third lower gusset connecting the first tubular member and the second tubular member, the mobile tower further comprising a drive motor mounted on the third lower gusset and a drive train drivably connecting the drive motor to at least one of the plurality of wheels.

13. The mobile tower of claim 12, the horizontally-extending spans including braces, the first diagonal leg and the second diagonal leg each including a brace connector for connecting to one of the braces.

14. The mobile tower of claim 11, the brace connectors being welded to the first diagonal leg and second diagonal leg.

15. The mobile tower of claim 11, the gusset connectors being welded to the tubular members.

16. The mobile tower of claim 11, the horizontally-extending spans including a conduit, the upper bracket including a U-shaped section for supporting the conduit.

17. The mobile tower of claim 16, the upper bracket further including a cap section configured to extend over the conduit, the U-shaped section and the cap section forming double shear connections with the gusset connectors of the first diagonal leg and the second diagonal leg.

18. The mobile tower of claim 11, the first diagonal leg and the second diagonal leg extending in a vertical plane.

19. The mobile tower of claim 11, the gusset connectors of the first diagonal leg extending parallel to an axis of the tubular member of the first diagonal leg and being oriented in different planes than each other, the gusset connectors of the second diagonal leg extending parallel to an axis of the tubular member of the second diagonal leg and being oriented in different planes than each other.

20. A mobile irrigation system comprising:
a central pivot including a support structure;
a fluid-carrying conduit supported by the central pivot and coupled to a fluid source;
a plurality of interconnected spans extending radially outward from the central pivot, each span including:
a plurality of fluid distribution members coupled to the conduit and configured to distribute fluid; and
a truss structure supporting the conduit and the plurality of fluid distribution members; and
a plurality of mobile towers each comprising:
a frame configured to support one of the horizontally-extending spans, the frame including:
a crossbeam including a tubular member having gusset connectors;
a first diagonal leg including a tubular member having gusset connectors extending parallel to an axis of the tubular member of the first diagonal leg and being oriented in different planes than each other;
a second diagonal leg including a tubular member having gusset connectors extending parallel to an axis of the tubular member of the second diagonal leg and being oriented in different planes than each other,
the first diagonal leg and the second diagonal leg extending in a vertical plane;
a first lower gusset connecting the first diagonal leg and the crossbeam via one of the gusset connectors of the first diagonal leg and one of the gusset connectors of the crossbeam;
a second lower gusset connecting the second diagonal leg and the crossbeam via one of the gusset connectors of the second diagonal leg and one of the gusset connectors of the crossbeam; and
an upper bracket connecting the first diagonal leg and the second diagonal leg via one of the gusset connectors of the first diagonal leg and one of the gusset connectors of the second diagonal leg,
the tubular members of the crossbeam, first diagonal leg, and second diagonal leg being interchangeable and adaptable with other tubular members; and
a plurality of wheels rotatably mounted on the frame for traversing a ground surface.
